(19) United States
(12) Patent Application Publication
(10) Pub. No.: US 2008/0161188 A1
(43) Pub. Date: Jul. 3, 2008

(54) HERBICIDAL COMPOSITIONS AND METHODS OF CONTROLLING WEED GROWTH

(76) Inventors: TIM ANDERSON, Hamilton, OH (US); Jianhua Mao, Cincinnati, OH (US)

Correspondence Address: COGNIS CORPORATION;PATENT DEPARTMENT, 300 BROOKSIDE AVENUE, AMBLER, PA, 19002, US

(21) Appl. No.: 11/937,563

(22) Filed: Nov. 9, 2007

Related U.S. Application Data
(60) Provisional application No. 60/882,629, filed on Dec. 29, 2006.

(51) Int. Cl. A01N 57/20; A01P 13/00

(52) U.S. Cl. 504/206

(57) ABSTRACT

An herbicidal composition which comprises a mixture of an herbicide and a C₂-C₅ mono- or dicarboxylic acid additive, and mixtures of additives thereof, wherein the composition is more effective in providing a faster-acting herbicidal effect than the herbicide alone is described. A method of controlling weed growth with the herbicidal composition is also described.

### CROSS-REFERENCE TO RELATED APPLICATIONS

This application claims priority under 35 U.S.C. Section 120 of U.S. Provisional Application Ser. No. 60/882,629 filed Dec. 29, 2006, which is incorporated herein by reference in its entirety.

### CROSS-REFERENCE TO RELATED APPLICATIONS

Not applicable

### FIELD OF THE INVENTION

The invention relates generally to herbicides, methods of improving the activity of existing herbicides, and controlling the growth of plant life, and more particularly to compositions containing C₂-C₅ mono or dicarboxylic acid additives, which additives can enhance the activity (effectiveness) of herbicides, and methods of use thereof.

### BACKGROUND OF THE INVENTION

The control of weeds (undesirable vegetation) has an enormous economic impact on the global economy. Not only is weed control imperative for economic success in agriculture, it also enables maintenance of roadsides and right of ways, reduces cover for mosquito reproduction enhancing public health and enhances the beauty of gardens and lawns. In many weed control applications, selective control of undesired vegetation without concurrent injury or damage to desirable vegetation is the ideal. In other applications, complete control of a broad spectrum (non-selective) is the ultimate goal. If one can market a non-selective herbicide and add low toxicity and fast action, the value demands of the home consumer market have been met.

Glyphosate and paraquat are the number 1 and 2 non-selective herbicides used worldwide. Paraquat is extremely toxic to humans and therefore valued less as a tool for vegetation control. Glyphosate, although low in toxicity, is known to require 1 to 2 weeks to achieve its visible control, and is therefore undesirable for fast-acting herbicidal applications.

Other conventionally known herbicides include fatty acids, such as pelargonic acid, a nine carbon fatty acid, and caprylic acid, an eight carbon fatty acid. SCYTHE™, sold by Mycogen/Dow, is an herbicide containing pelargonic acid as the active ingredient. LIBERTY™, made by Bayer Crop Science, is a commercially available herbicide containing glufosinate-ammonium as the active ingredient.

Ready-to-use weed control agents exhibiting fast-acting efficacious results remain in high demand for residential consumers. Consumers want effective herbicides which are fast-acting in controlling weeds. They want to see the effectiveness of the treatment within 24 hours of application.

Long chain fatty acids of from C₆ to C₂₀ in length, especially C₉ acids, have been used in currently available commercial herbicidal compositions. Such long chain fatty acids are less soluble in water, and thus require the addition of solvent or an emulsifier to enhance their solubility and to prevent aqueous and lipid phase separation. Therefore, alternative reagents remain in demand.

Accordingly, it is desirable to provide improved herbicidal compositions, methods for enhancing the activity of existing herbicides, and methods of controlling plant growth, in order to overcome the shortcomings of the prior art.

### BRIEF SUMMARY OF THE INVENTION

To address the shortcomings of the prior art, the invention provides an herbicidal composition which comprises a mixture of an herbicide and a C₂-C₅ mono- or dicarboxylic acid additive, and mixtures of additives thereof, wherein the mixture of the herbicidal composition provides a faster-acting herbicidal effect than the herbicide alone.

Accordingly, one aspect of the invention provides herbicidal compositions possessing faster-acting herbicidal effects with regard to controlling weed growth over that of the herbicide alone.

Another aspect then of the invention provides additives, which additives enhance the effect of commercial herbicides, thus providing improved herbicidal compositions.

Yet another aspect of the invention is a method of applying the herbicidal compositions to plants and grasses so as to achieve faster-acting weed control.

### DETAILED DESCRIPTION OF THE INVENTION

Other than in the operating examples, all numbers expressing quantities of ingredients or reaction conditions are to be understood as being modified in all instances by the term “about.”

As used herein, “herbicidal” refers to compounds which kill or inhibit plant growth, such as by desiccation or defoliation, for example; by acting as a harvest aid; or by controlling weed growth.

The additives for the herbicidal compositions of the invention are C₂-C₅ fatty acids, which fatty acids are mono- or dicarboxylic acids. These additives in mixture with an herbicide provide an improved composition for controlling and killing weeds over that of the herbicide alone. The compositions of the invention thus provide the desired faster-acting effects of weed control and killing over the herbicide alone.

It shall be understood that the additives of C₂-C₅ fatty acids encompass unsubstituted and substituted embodiments, such as, for example, hydroxyl or amine-substituted acids.

Examples of suitable additives for use in the invention include acetic acid, propionic acid, lactic acid, butyric acid, maleic acid, malic acid, glutaric acid, glutamic acid, fumaric acid, tartaric acid, and mixtures thereof. Lactic acid has been found to be particularly effective.

It is considered that one can enhance the herbicidal activity of any herbicide in admixture with the additives described above to achieve improved herbicidal compositions by way of the invention. Herbicides which have achieved the status of G.R.A.S. (generally recognized as safe by the EPA) are particularly of interest.

Non-limiting examples of herbicides which can be employed in the compositions of the invention include atrazine, bentazon, bromacil, casoron, chloramben, delapon, diuron, fluormeturon, glyphosate, linuron, paraquat, picloram, phenoxy-based herbicides and trifluralin. Of particular interest is glyphosate and its salts thereof.

Concentrations of herbicides and activity-enhancing additives applied to plants and weeds in accordance with the invention can include compositions containing from about 0.1 to 30% by weight of herbicide and additive, preferably about 0.5 to 15% herbicide and additive, and more preferably, about 1 to 8% herbicide and additive. The weight ratio of herbicide to activity-enhancing additive can be from about 1:1 to 20:1, preferably, about 1:10 to 10:1, and, more preferably, about 1:2 to 2:1.

The additive may be present in an amount of from about 1% to about 5% by weight of the total weight of the composition, preferably from about 2% to about 5% by weight.

Herbicides can be provided in concentrated form and then readily diluted at the point of use.

Non-limiting examples of weeds which can be controlled more efficiently and faster by way of the invention include perennial rye grass, fescue, crabgrass, chickweed, basket grass, and clover.

The compositions of the invention may be mixed with a liquid carrier or diluent, such as water, and applied, for example by spraying, to the target weeds. Other suitable carriers or diluents which may be used include acetophenone, cyclohexanone, isophorone, toluene, xylene, and mineral, animal and vegetable oils (these diluents may be used alone or in combination).

The herbicidal composition of the present invention may also include various types of auxiliaries, adjuvants, solvents, and co-solvents, which serve to further enhance the performance of the improved compositions of the invention.

Suitable nonionic surfactants for use in the present invention include alkoxylated fatty alcohols, alkoxylated fatty acids, alkoxylated fatty ethers, alkoxylated fatty amides, ethoxylated seed oils, ethoxylated mineral oils, nonylphenol ethoxylates, alkoxylated alkyl phenols, ethoxylated glycerides, castor oil ethoxylates, and mixtures thereof.

The anionic surfactants that can be used in the compositions according to the invention can include an ethoxylated partial phosphate ester, an alkyl sulfate, an alkyl ether sulfate, a branched alkyl benzene sulfonate, a linear alkyl benzene sulfonate, and an alpha olefin sulfonate.

The alkyl sulfates that can be used in the compositions according to the invention are those wherein the alkyl group has from about 6 to about 22 carbon atoms. The alkyl ether sulfates that can be used in the compositions according to the invention are those wherein the alkyl group has from about 6 to about 22 carbon atoms. The branched alkyl benzene sulfonates that can be used in the compositions according to the invention are those wherein the alkyl group can be branched and has from about 6 to about 22 carbon atoms. The linear alkyl benzene sulfonates that can be used in the compositions according to the invention are those wherein the alkyl group is an essentially unbranched alkyl group having from about 6 to about 22 carbon atoms. The alpha olefin sulfonates that can be used in the compositions according to the invention are those wherein the alkyl group has from about 6 to about 22 carbon atoms.

Auxiliary components may also be added to the compositions of the invention in order to further enhance the properties thereof. Examples thereof include, but are not limited to, solvents and co-solvents, water-soluble silicone surfactants, oil-soluble silicone surfactants, cationic surfactants, amphoteric surfactants, and the like.

Cationic surfactants which may be employed include, but are not limited to, ethoxylated amines such as ethoxylated tallow amine.

Amphoteric surfactants which may be employed include, but are not limited to, amino acids and their derivatives, amino acid salts, imidazolinium derivatives, alkyl betaines and amidopropyl analogues.

The following is illustrative of the present invention and should not be construed in any manner whatsoever as limiting the scope of the present invention.

### EXAMPLE(S)

A standard ready to use composition of the herbicide glyphosate was prepared as follows:

| Ingredient | Weight Percent |
|---|---|
| Water | 95.27 |
| Glyphosate | 2.00 |
| Isopropylamine salt | |
| Tallow Amine POE 20 | 0.51 |
| Glycerin | 0.11 |
| Propylene Glycol | 0.11 |
| Fatty acid additive | 2.00 |

This composition included all of the water necessary to apply for weed control and was not further diluted.

To test the fast weed control effects, one trial was made with water replacing the (2.00% wt/wt) “Fatty acid additive.” This allowed direct comparison of the faster-acting weed control provided by the additives used in the compositions of the invention.

The test plots included several species including perennial rye grass, fescue, crabgrass, and several unidentified broad-leaf weeds. As this is a non-selective test, all growing plants (monocot and broadleaf) were evaluated as one species referred to as “turf.” Test plots were 4-ft by 60 ft rectangles with untreated check plots to either side. Evaluations were made at 3 days, 7 days and 14 days by visually inspecting each plot comparing health and vigor of turf (color and mortality) to adjacent untreated controls. The chart below shows the rate of control for turf:

| | Fatty Acid Additives | | | | |
|---|---|---|---|---|---|
| | | | | | 5% |
| Days after | Water | 2% Acetic | 2% Lactic | 4% Lactic | Butyric |
| Treatment | Control | Acid | Acid | Acid | Acid |
| 3 | 10% | 30% | 40% | 30% | 15% |
| 7 | 20% | 35% | 65% | 85% | 65% |
| 14 | 90% | 100% | 100% | 95% | 95% |

% Control = Dead or stressed turf

The test results demonstrate the faster-acting effects of herbicidal compositions containing short chain fatty acid additives in enhancing the rate of weed control in herbicide compositions versus the same compositions without (water control) short chain fatty acid.

What we claim is:

1. An herbicidal composition which comprises a mixture of an herbicide and a C₂-C₅ mono- or dicarboxylic acid additive, and mixtures of additives thereof, wherein the composition provides a faster-acting herbicidal effect than the herbicide alone.

2. The herbicidal composition of claim 1 wherein the additive is selected from the group consisting of acetic acid, propionic acid, lactic acid, butyric acid, maleic acids malic acid, glutaric acid, glutamic acid, fumaric acid, tartaric acid, and mixtures thereof.

3. The herbicidal composition of claim 2 wherein the additive is selected from the group consisting of acetic acid, lactic acid and butyric acid, and mixtures thereof.

4. The herbicidal composition of claim 3 wherein the additive is lactic acid.

5. The herbicidal composition of claim 1 wherein the additive is present at from about 1% to about 5% by weight, based on the weight of the composition.

6. The herbicidal composition of claim 1 wherein the herbicide and additive are present in an amount of about 0.1 to 30% by weight of the composition.

7. The herbicidal composition of claim 6 wherein the herbicide and additive are present in an amount of about 1 to 8% by weight of the composition.

8. The herbicidal composition of claim 1 having a weight ratio of herbicide to additive of from about 1:1 to 20:1.

9. The herbicidal composition of claim 8 wherein the weight ratio of herbicide to additive is from about 1:2 to 2:1.

10. The herbicidal composition of claim 1 which further comprises a surfactant.

11. The herbicidal composition of claim 1 which is a concentrate suitable for dilution prior to use.

12. A method of controlling weed growth which comprises applying to a weed an herbicidal composition, which composition comprises a mixture of an herbicide and a C₂-C₅ mono- or dicarboxylic acid additive, and mixtures of additives thereof, wherein the composition provides a faster-acting herbicidal effect than the herbicide alone.
